(19) United States
(12) Patent Application Publication
(10) Pub. No.: US 2026/0196619 A1
(43) Pub. Date: Jul. 9, 2026

(54) CAP ASSEMBLY INCLUDING A SEALING GASKET, BATTERY CELL INCLUDING THE SAME, AND BATTERY MODULE

(71) Applicant: SK On Co., Ltd., Seoul (KR)

(72) Inventor: Hoemin CHEONG, Daejeon (KR)

(21) Appl. No.: 19/430,286

(22) Filed: Dec. 23, 2025

(30) Foreign Application Priority Data
Jan. 3, 2025 (KR) 10-2025-0000754

(51) Int. Cl. H01M 50/152; H01M 50/107; H01M 50/169; H01M 50/171

(52) U.S. Cl. CPC H01M 50/152; H01M 50/107; H01M 50/169; H01M 50/171

(57) ABSTRACT

The present disclosure provides a battery cell, comprising a cell case including a side wall forming a receiving space therein, and an end plate having a through-hole formed therein; an electrode assembly disposed in the receiving space of the cell case; and a cap assembly sealing the cell case, wherein the cap assembly comprises a cap plate covering one side of the cell case; a sealing gasket disposed between the cap plate and the cell case; and a fusion region formed by fusion of at least a portion of a contact surface between the sealing gasket and the cap plate, and wherein one of the sealing gasket and the cap plate includes a protrusion, and the other includes an insertion groove into which the protrusion is inserted.

### CROSS-REFERENCE TO RELATED APPLICATIONS

This application claims the benefit of priority to Korean Patent Application No. 10-2025-0000754 filed on January 03, 2025 in the Korean Intellectual Property Office, the disclosure of which is incorporated herein by reference in its entirety.

### TECHNICAL FIELD

The present disclosure relates to a cap assembly including a sealing gasket, a battery cell including the same, and a battery module.

### BACKGROUND

Secondary battery cells, unlike primary batteries, offer the convenience of being rechargeable and dischargeable, and are attracting significant attention as power sources such as for various mobile devices, electric vehicles, and energy storage devices.

Secondary battery cells may be manufactured as pouch-type cells or can-type cells. Pouch-type cells have a structure in which an electrode assembly is accommodated within a flexible cell case (pouch). Can-type cells have a structure in which an electrode assembly is housed within a rigid cell case (can) and may be configured as cylindrical cells, prismatic cells, coin-type cells, and the like.

### SUMMARY

To prevent leakage of materials from the cell case, the battery cell uses a sealing gasket between the cap plate and the can. However, during the process of fusing the sealing gasket to the cap plate to improve sealing performance thereof, it was difficult to secure the sealing gasket to the cap plate.

According to one aspect of the present disclosure, the sealing performance of the sealing gasket may be improved.

According to another aspect of the present disclosure, the sealing gasket may be fused while being secured to the cap plate.

A cap assembly including a sealing gasket, a battery cell including the same, and a battery module according to the present disclosure, may be widely applied to devices within green technology fields such as electric vehicles, battery charging stations, and other battery-storage solar and wind power electricity generation devices. Furthermore, a cap assembly including a sealing gasket, a battery cell including the same, and a battery module of the present disclosure, may be used in eco-friendly electric vehicles, hybrid vehicles, and other vehicles that help to ameliorate the effects of climate change by reducing air pollution and greenhouse gas emissions.

A battery cell according to the present disclosure comprises a cell case including a side wall forming a receiving space therein and an end plate having a through-hole formed therein; an electrode assembly disposed in the receiving space of the cell case; and a cap assembly sealing the cell case; wherein the cap assembly comprises a cap plate covering one side of the cell case; a sealing gasket disposed between the cap plate and the cell case; and a fusion region formed by fusion of at least a portion of a contact surface between the sealing gasket and the cap plate, wherein one of the sealing gasket and the cap plate may include a protrusion, and the other may include an insertion groove into which the protrusion is inserted.

According to an embodiment, the cap plate comprises a first surface facing the receiving space, a second surface facing in an opposite direction to the first surface, and a third surface connecting the first surface to the second surface at the periphery of the first surface and the second surface, and the fusion region may be formed on the first surface.

According to an embodiment, the protrusion and the insertion groove may be formed in a region in which the sealing gasket comes into contact with the first surface.

According to an embodiment, the fusion region may include a first fusion region formed in a direction toward the center of the cap plate, relative to the protrusion, and a second fusion region formed in a direction opposite to the direction toward the center of the cap plate, relative to the protrusion.

According to an embodiment, the fusion region may be formed by laser welding or ultrasonic welding.

A cap assembly according to the present disclosure includes a cap plate covering one side of a cell case; and a sealing gasket disposed between the cap plate and the cell case, wherein at least a portion of a contact surface between the sealing gasket and the cap plate is fused to form a fusion region, and wherein one of the sealing gasket and the cap plate may include a protrusion, and the other may include an insertion groove into which the protrusion is inserted.

According to an embodiment, the protrusion may include a plurality of protrusions, and the insertion groove may include a plurality of insertion grooves.

According to an embodiment, the sealing gasket may include a body and an extension portion extending from the body, wherein the extension portion may include a convex portion protruding toward the center of the cap plate.

According to an embodiment, the body may include a concave portion having at least a portion formed thinner than other portions thereof.

According to an embodiment, the cap plate may include a first surface facing the body, a second surface facing in an opposite direction to the first surface, and a third surface connecting the first surface to the second surface at the periphery of the first surface and the second surface, and wherein the fusion region may be formed on the first surface.

According to an embodiment, the protrusion and the insertion groove may be formed in a region in which the sealing gasket comes into contact with the first surface.

According to an embodiment, the cap plate may have a circular plate shape, and the fusion region may have a ring shape formed between the first surface and the body.

According to an embodiment, the fusion region may include a first fusion region formed in a direction toward the center of the cap plate, relative to the protrusion, and a second fusion region formed in a direction opposite to the direction toward the center of the cap plate, relative to the protrusion.

According to an embodiment, the fusion region may be formed by laser welding or ultrasonic welding.

A battery module according to the present disclosure includes a plurality of battery cells; and a module housing accommodating the plurality of battery cells, wherein at least one of the plurality of battery cells includes a cell case including a side wall forming a receiving space therein and an end plate having a through-hole formed therein; an electrode assembly disposed in the receiving space of the cell case; and a cap assembly sealing the cell case; wherein the cap assembly includes a cap plate covering one side of the cell case; a sealing gasket disposed between the cap plate and the cell case; and a fusion region formed by fusion of at least a portion of the contact surface between the sealing gasket and the cap plate, and wherein one of the sealing gasket and the cap plate may include a protrusion, and the other may include an insertion groove into which the protrusion is inserted.

According to an embodiment of the present disclosure, the sealing performance of the sealing gasket may be improved.

According to an embodiment of the present disclosure, the sealing gasket may be fused while being fixed to the cap plate.

However, the various and beneficial advantages and effects of the present disclosure are not restricted to those set forth herein, and will be more easily understood in the process of describing specific embodiments.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a battery cell according to an embodiment;

FIG. 2 is a cross-sectional view taken along line I-I' of FIG. 1;

FIG. 3 is an enlarged view of portion “A” of FIG. 1;

FIG. 4 is a perspective view schematically illustrating a process for manufacturing a cap assembly according to an embodiment;

FIG. 5 is a partial cross-sectional view of a laser-welded cap assembly;

FIG. 6 is a partial cross-sectional view of an ultrasonic-welded cap assembly;

FIG. 7 is a partial cross-sectional view of a cap assembly according to another embodiment;

FIG. 8 is a partial cross-sectional view of a cap assembly according to yet another embodiment; and

FIG. 9 is a perspective view of a battery module according to an embodiment.

### DETAILED DESCRIPTION

The same reference numbers or symbols in each drawing attached to this specification represent parts or components that perform substantially the same functions. For convenience of description and understanding, the same reference numbers or symbols may be used in different embodiments. In other words, even if components with the same reference numbers are depicted in multiple drawings, they do not necessarily represent a single embodiment.

In the following description, the singular expression “a,” “an,” and “the” include the plural expression unless the context clearly indicates otherwise. Terms such as “comprise” or “configure” are intended to indicate the presence of features, numbers, steps, operations, components, parts, or combinations thereof described in the specification, but should be understood not to preclude the presence or addition of one or more other features, numbers, steps, operations, components, parts, or combinations thereof.

In addition, in the following description, terms such as “top,” “upper,” “lower,” “bottom,” “side,” “front,” and “rear” are expressed based on the directions depicted in the drawings, and it is noted in advance that they may be expressed differently if the direction of the corresponding object changes.

Furthermore, terms including ordinal numbers, such as “first,” “second,” etc., may be used in this specification and claims to distinguish between components. These ordinal numbers are used to distinguish identical or similar components, and the meaning of the terms should not be limited due to the use of these ordinal numbers. For example, the order of use or arrangement of components associated with these ordinal numbers should not be construed as limited by their numbers. If necessary, each ordinal number may be used interchangeably.

Hereinafter, the present disclosure will be described in detail with reference to the attached drawings. However, these are merely illustrative and the present disclosure is not limited to the specific embodiments illustrated by the drawings.

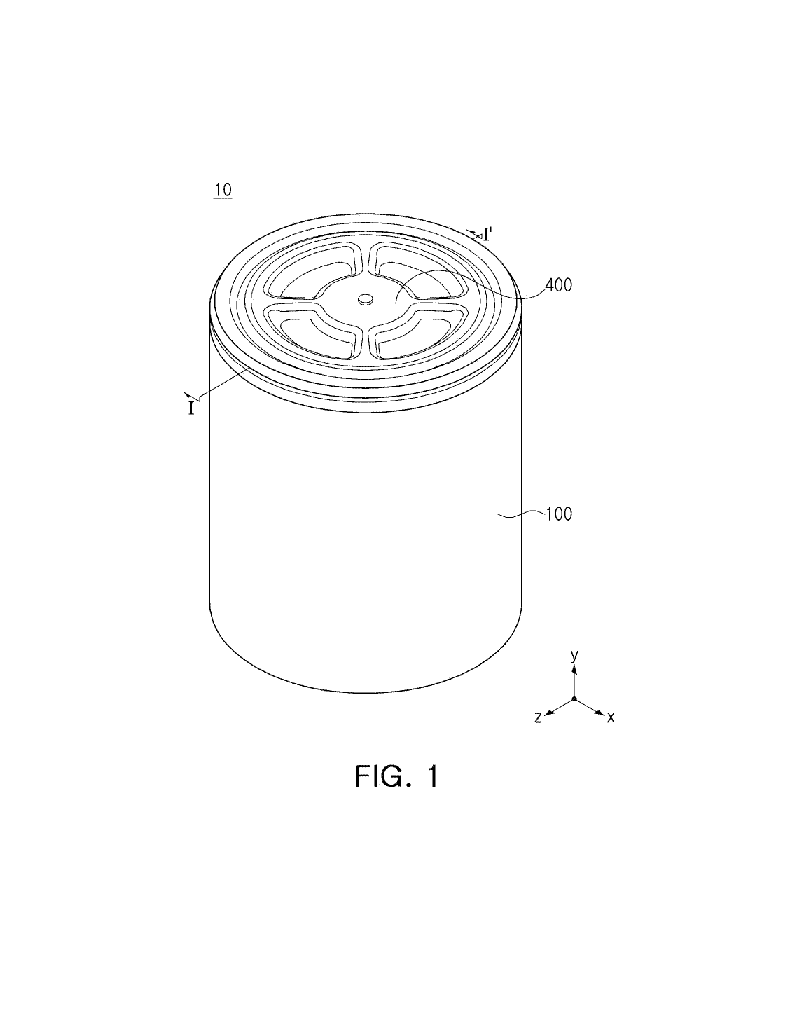

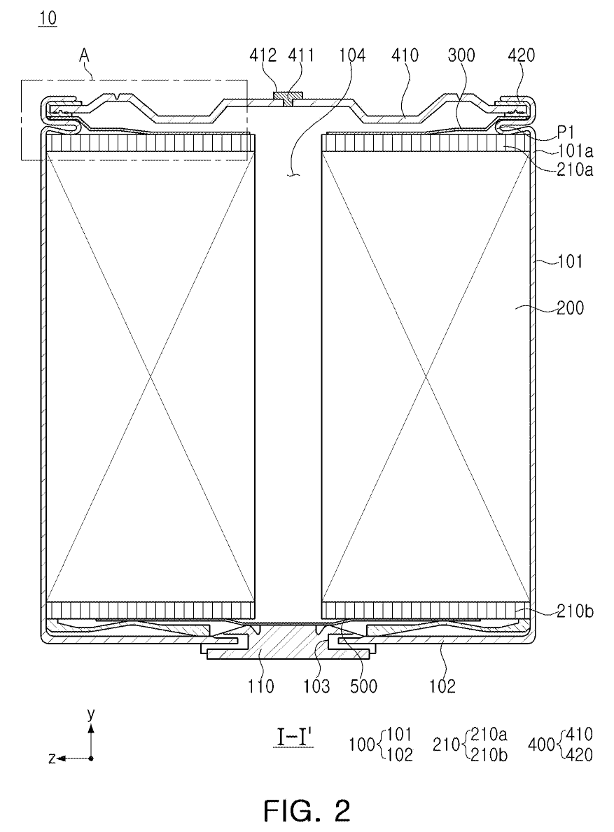

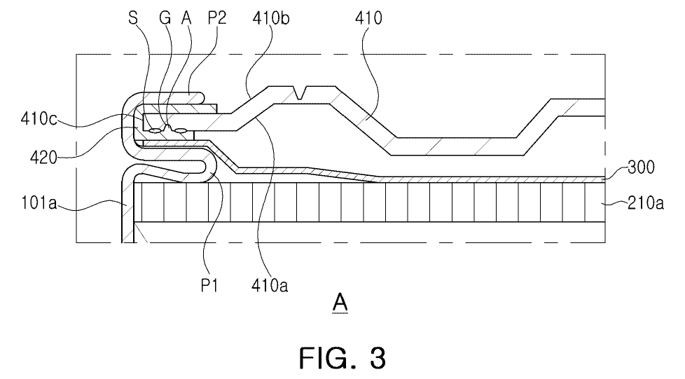

FIG. 1 is a perspective view of a battery cell 10 according to an embodiment. FIG. 2 is a cross-sectional view taken along line I-I’ of FIG. 1. FIG. 3 is an enlarged view of part “A” of FIG. 1.

Referring to FIGS. 1 to 3, a battery cell 10 according to an embodiment may include a cell case 100 including a side wall 101 forming a receiving space 104 therein and an end plate 102 having a through-hole 103 formed therein, and an electrode assembly 200 disposed in the receiving space 104 of the cell case 100.

The electrode assembly 200 may include a positive electrode plate, a negative electrode plate, and a separator. The separator may be composed of an insulator interposed between the negative electrode plate and the positive electrode plate. The electrode assembly 200 may be configured as a stack type in which the positive electrode plate, the negative electrode plate, and the separator are alternately stacked. Alternatively, the electrode assembly 200 may be configured as a winding type in which the positive electrode plate, the negative electrode plate, and the separator interposed between the positive and negative electrode plates are wound in a roll shape. While the electrode assembly 200 is illustrated as being a winding type in the present disclosure, it is not necessarily limited thereto.

The positive and negative electrode plates may each have a structure in which a positive electrode active material or a negative electrode active material is coated on a foil. For example, the negative electrode plate may be formed by coating graphite or other materials on a copper or nickel foil, and the positive electrode plate may be formed by coating a transition metal oxide active material on an aluminum foil.

The electrode assembly 200 may include an electrode tab 210. The electrode tab 210 may include a negative electrode tab 210a and a positive electrode tab 210b. At least some portions of the positive and negative plates may not be coated with an active material. The portions of the positive and negative plates that are not coated with an active material may be referred to as non-coated portions. The non-coated portions may protrude vertically. That is, the protruding non-coated portions of the positive and negative plates may function as positive electrode tabs 210b and negative electrode tabs 210a, respectively.

The electrode tabs 210 of the electrode assembly 200 may be brought into contact with the current collecting plate 300 to be electrically connected thereto, and the electrode tabs 210 and the current collecting plate 300 may be joined to each other by welding such as ultrasonic welding or laser welding. However, a method of joining the electrode tabs 210 and the current collecting plate 300 is not limited thereto.

The cell case 100 may accommodate the electrode assembly 200. In other words, the electrode assembly 200 may be accommodated in the cell case 100.

The cell case 100 may include a side wall 101 forming a receiving space 104 therein and an end plate 102 having a through-hole 103 formed therein. The receiving space 104 may be formed by the side wall 101 and the end plate 102 of the cell case 100. The cell case 100 may have a cylindrical shape with one side open. The cell case 100 may have a hollow cylindrical shape with a circular cross-section.

The side wall 101 may have a tube shape, and the end plate 102 may have a plate shape covering the bottom side of the receiving space 104. The side wall 101 may have a circular tube shape. The end plate 102 may have an overall flat plate shape. The thickness of the end plate 102 and the side wall 101 in the cell case 100 may be varied. For example, the end plate 102 and the side wall 101 may have the same thickness, or the thickness of the end plate 102 may be greater than the thickness of the side wall 101. The cell case 100 may include a metal material such as aluminum or an aluminum alloy, but the material of the cell case 100 may be varied.

The side wall 101 and the end plate 102 of the cell case 100 may be formed integrally. For example, the cell case 100 may be manufactured in a shape in which the side wall 101 and the end plate 102 are formed integrally by deep drawing a metal sheet. When the cell case 100 is formed integrally, the process of joining the side wall 101 and the end plate 102 is not required, thereby facilitating the manufacturing of the cell case 100 and/or the battery cell 10, and improving workability.

However, the cell case 100 of the present disclosure is not limited to a configuration in which the side wall 101 and the end plate 102 are formed integrally. The side wall 101 and the end plate 102 may also be manufactured separately and then joined or bonded to each other by welding or the like.

A through-hole 103 may be formed in the end plate 102 of the cell case 100. The through-hole 103 may be provided for joining the electrode terminal 110. The cell case 100 has a circular cross-sectional shape, and the through-hole 103 may be formed in the center of the end plate 102. In this case, the electrode terminal 110 coupled to the through-hole 103 may be disposed at the center of the end plate 102.

The electrode terminal 110 may be coupled to the through-hole 103. At least a portion of the electrode terminal 110 may be exposed to the outside of the cell case 100. In addition, at least a portion of the electrode terminal 110 may be disposed in the receiving space 104 of the cell case 100 and may be electrically connected to a current collector 500. That is, the electrode terminal 110 may pass through the through-hole 103 and be electrically connected to the current collector 500. Accordingly, when the current collector 500 is coupled to the positive electrode tab 210b, the electrode terminal 110 may correspond to the positive electrode terminal, and vice versa.

A battery cell 10 according to an embodiment may include a cap assembly 400 sealing a cell case 100. The cap assembly 400 may include a cap plate 410 that covers one side of the cell case 100. The cap plate 410 may cover the receiving space 104 on the opposite side from the end plate 102. That is, the cap plate 410 may seal the opening of the cell case 100.

The cap plate 410 may include a first surface 410a that faces the receiving space 104, a second surface 410b that faces in a direction opposite to the first surface 410a, and a third surface 410c connecting the first surface 410a with the second surface 410b at the periphery of the first surface 410a and the second surface 410b.

The cap plate 410 may be joined to the side wall 101 of the cell case 100 by crimping, welding, or the like. For example, after forming a beaded portion (P1) by performing beading processing on an open end 101a of the side wall 101 of the cell case 100, a cap plate 410 having a sealing gasket 420 bonded thereto is placed on the beaded portion (P1), and then the end 101a of the side wall 101 and the cap plate 410 are crimped to form a crimped portion (P2).

The cap plate 410 may be provided with a liquid injection port 411 for injecting electrolyte into the interior of the cell case 100. The liquid injection port 411 may be formed in the center of the cap plate 410, but its location and size may vary. The liquid injection port 411 may be sealed with an injection port stopper 412 after the electrolyte is injected.

The cap assembly 400 may include a sealing gasket 420 disposed between the cap plate 410 and the cell case 100.

The sealing gasket 420 may be disposed between the cap plate 410 and the cell case 100 to insulate the cap plate 410 and the cell case 100. The sealing gasket 420 may be disposed between the cap plate 410 and the side wall 101 of the cell case 100 for sealing purposes. The sealing gasket 420 may serve as a sealing member sealing the space between the cap plate 410 and the side wall 101.

The cap assembly 400 may include a fusion region (S) formed by fusion of at least a portion of the contact surface between the sealing gasket 420 and the cap plate 410. The fusion region (S) may be formed by laser welding or ultrasonic welding. By forming the fusion region (S), the sealing performance of the sealing gasket 420 may be improved.

One of the sealing gasket 420 and the cap plate 410 may include a protrusion (A), and the other may include an insertion groove (G) into which the protrusion (A) is inserted. The protrusion (A) and the insertion groove (G) may secure the sealing gasket 420 and the cap plate 410 during the formation of the fusion region (S), thereby preventing misalignment.

Various embodiments and detailed descriptions of the fusion region (S), the protrusion (A), and the insertion groove (G) will be described below.

The battery cell 10 according to an embodiment may further include a current collecting plate 300 electrically connected to the electrode tab 210 of the electrode assembly 200. A lower surface of the current collecting plate 300 may be configured to be joined or in contact with the electrode tab 210 so as to be electrically connected to the electrode tab 210. Welding may be used to join the current collecting plate 300 and the electrode tab 210. For example, the current collecting plate 300 and the electrode tab 210 may be joined by ultrasonic welding, laser welding, resistance welding, or the like. Alternatively, the current collecting plate 300 and the electrode tab 210 may also be electrically connected while being in contact with each other without being joined.

The current collecting plate 300 may be electrically connected to at least one of the cap plate 410 or the side wall 101 of the cell case 100. In this case, the cap plate 410 and/or the cell case 100 may have polarity. For example, if the current collecting plate 300 is electrically connected to the negative electrode tab 210a, the cap plate 410 and/or the cell case 100 may be charged negatively. The object electrically connected to the current collecting plate 300 may vary depending on the design specifications of the battery cell 10.

Meanwhile, a configuration in which the current collecting plate 300 is not disposed and the electrode tab 210 is directly electrically connected to the cap plate 410 is also possible.

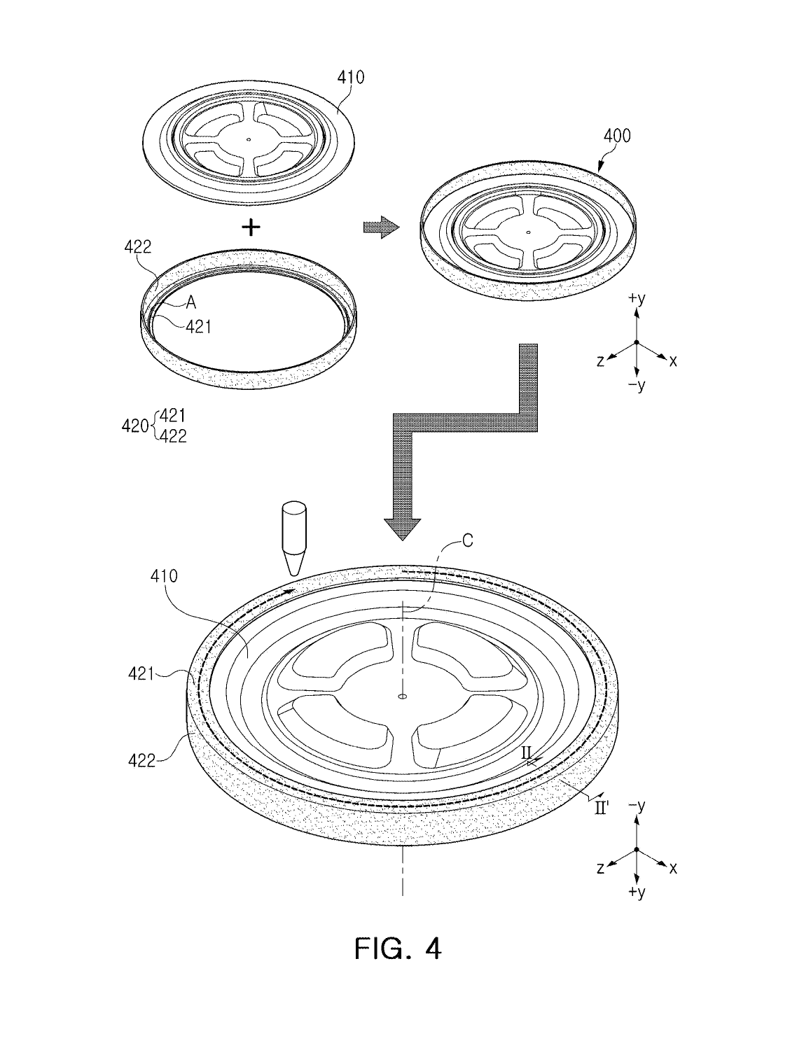

FIG. 4 is a perspective view schematically illustrating the manufacturing process of a cap assembly 400 according to an embodiment.

The descriptions of the cap assembly 400 described in FIGS. 1 to 3 may also be applied to the cap assembly of FIG. 4.

Referring to FIGS. 1 to 4, the cap assembly 400 may be formed by assembling a cap plate 410 and a sealing gasket 420.

The cap plate 410 may have a circular plate shape. The center of the circular plate may be referred to as a central axis (C). The sealing gasket 420 may include a body 421 and an extension portion 422 extending from the body 421. The body 421 may be in contact with a first surface 410a of the cap plate 410. Specifically, one surface of the body 421 may be in contact with the first surface 410a that is arranged to face the receiving space 104 of the cap plate 410. In other words, the first surface 410a of the cap plate 410 may be disposed to face the body 421 of the sealing gasket 420. The extension portion 422 may extend in a direction (+Y) perpendicular to the body 421.

The sealing gasket 420 may include a circular hollow space in the center. Additionally, the longitudinal cross-section of the sealing gasket 420 may have an ‘L’ shape.

The sealing gasket 420 may be deformed during the process of being coupled to the cell case 100. The cap assembly 400 may be crimped and coupled to the end portion 101a of the side wall 101 while disposed on the beading portion (P1). During the crimping process, a crimping portion (P2) is formed, and the shape of the sealing gasket 420 may be deformed. The longitudinal cross-section of the modified sealing gasket 420 may include a “C” shape (see FIG. 3).

The cap plate 410 may be assembled to contact the body 421 of the sealing gasket 420. Welding may be performed in a direction opposite (-Y) to the surface of the body 421 that contacts the cap plate 410. For example, the laser welder 11 may irradiate the laser in a circular direction along the body 421 from a direction opposite (-Y) to the surface of the body 421 that contacts the cap plate 410.

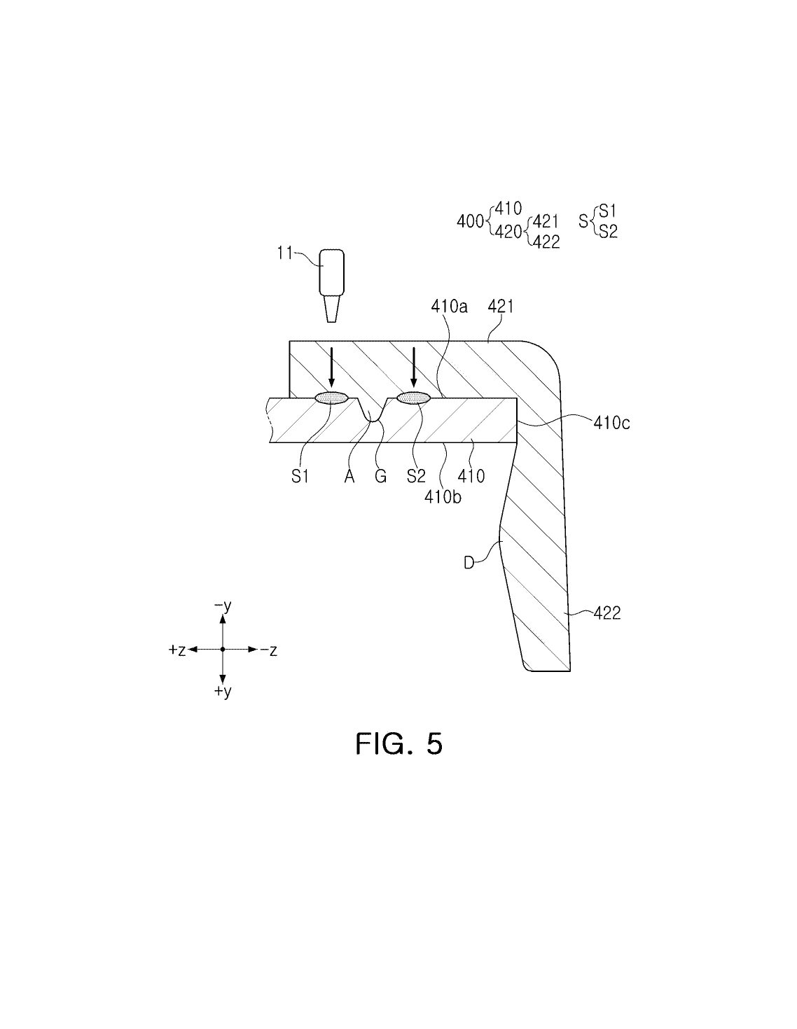

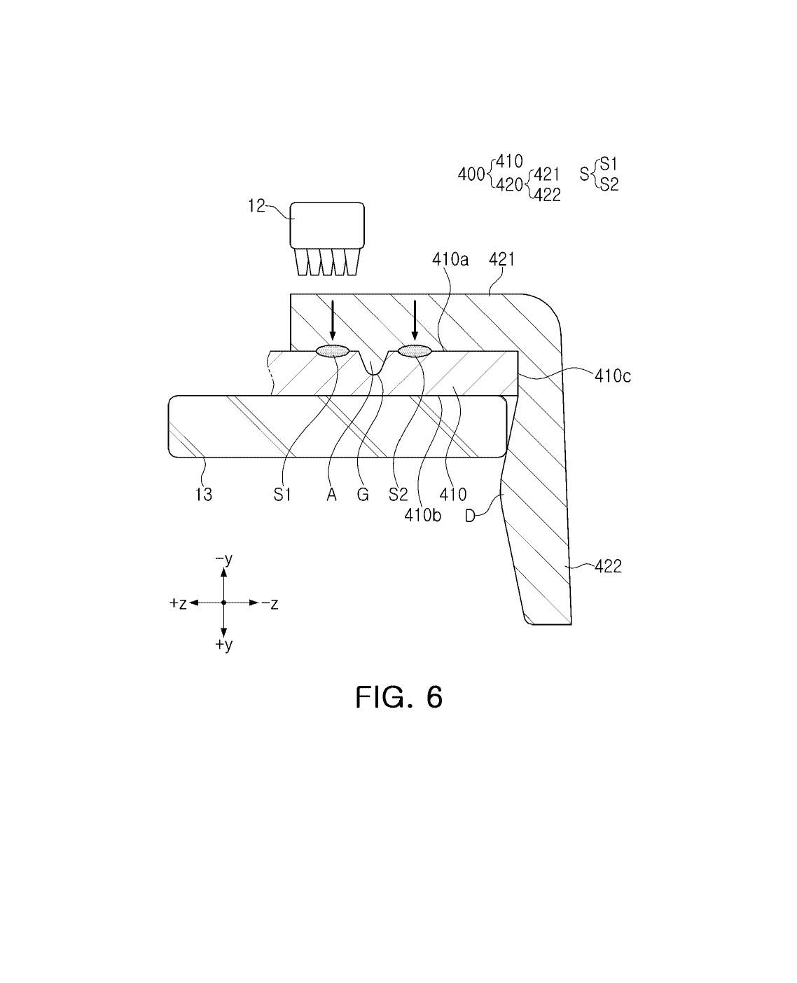

A detailed description of the process of forming the fusion region (S) will be described later with reference to FIGS. 5 and 6.

FIG. 5 is a partial cross-sectional view of a cap assembly 400 subjected to laser welding. FIG. 6 is a partial cross-sectional view of a cap assembly 400 subjected to ultrasonic welding.

The description of the cap assembly 400 described in FIGS. 1 to 4 may also be applied to the cap assembly 400 of FIGS. 5 and 6.

Referring to FIGS. 5 and 6, according to an embodiment, at least a portion of the contact surface between the sealing gasket 420 and the cap plate 410 may be fused to form a fusion region (S). The fusion region (S) may be formed by laser welding or ultrasonic welding. As the fusion region (S) is formed, the sealing performance of the sealing gasket 420 may be improved.

As the sealing performance of the sealing gasket 420 is improved by the fusion region (S), the sealing gasket 420 may be formed from a wider variety of materials than conventional materials. The sealing gasket 420 may include at least one of polybutylene terephthalate (PBT), perfluoroalkoxy (PFA), high-density polyethylene (HDPE), ultra-high molecular weight polyethylene (UHMW), low-density polyethylene (LDPE), linear low-density polyethylene (LLDPE), ultra linear low-density polyethylene (ULLDPE), medium-density polyethylene (MDPE), high-performance polypropylene (HPP), cast polypropylene (CPP), thermoplastic polyurethane (TPU), acrylonitrile butadiene styrene (ABS), high impact polystyrene (HIPS), and flexible polyvinyl chloride (FPVC).

The fusion region (S) may be formed on the first surface 410a of the cap plate 410. Specifically, the fusion region (S) may be formed on the contact surface between the sealing gasket 420 and the first surface 410a of the cap plate 410.

Welding may be performed in the opposite direction (-Y) of the surface of the body 421 that contacts the cap plate 410. For example, the laser welder 11 may irradiate a laser in a circular manner along the body 421 in the opposite direction (-Y) of the surface of the body 421 that contacts the cap plate 410. The laser may penetrate the body 421 to form a fusion region (S) on the first surface 410a. Therefore, the fusion region (S) may include a ring shape formed between the first surface 410a and the body 421. The fusion region (S) may enhance the sealing performance of the sealing gasket 420.

As another example, a horn 12 may generate ultrasonic waves along the body 421 in a direction opposite (-Y) to the surface of the body 421 that contacts the cap plate 410. The ultrasonic waves may generate heat on the surface of the body 421 that contacts the first surface 410a, thereby forming a fusion region (S). The fusion region (S) may enhance the sealing performance of the sealing gasket 420. At this time, the sealing gasket 420 and the cap plate 410 may be placed between the horn 12 and an anvil 13.

One of the sealing gasket 420 and the cap plate 410 may further include a protrusion (A), and the other of the sealing gasket 420 and the cap plate 410 may further include an insertion groove (G) into which the protrusion (A) is inserted. For example, the sealing gasket 420 may include a protrusion (A), and the cap plate 410 may include an insertion groove (G) into which the protrusion (A) is inserted. The protrusion (A) and the insertion groove (G) may secure the sealing gasket 420 to the cap plate 410 when forming the fusion region (S), thereby preventing misalignment. Therefore, the fusion region (S) may be formed at a desired location, and a uniform fusion region (S) may be formed.

The protrusion (A) and the insertion groove (G) may be formed in a region in which the first surface 410a is provided. Specifically, the protrusion (A) and the insertion groove (G) may be formed in a region in which the sealing gasket 420 comes into contact with the first surface 410a of the cap plate 410. Accordingly, the fusion region (S) may include a first fusion region (S1) formed in a direction (+Z) toward the center of the cap plate 410 relative to the protrusion (A), and a second fusion region (S2) formed in a direction (-Z) opposite to the direction toward the center of the cap plate 410 relative to the protrusion (A). The center of the cap plate 410 may refer to a region adjacent to the central axis (C) of the cap plate 410. Accordingly, the direction toward the center of the cap plate 410 may be the same as the direction toward the central axis (C) of the cap plate 410.

The extension portion 422 of the sealing gasket 420 may include a convex portion (D) that protrudes in a direction (+Z) toward the center of the cap plate 410. The convex portion (D) may prevent the cap plate 410 from detaching during welding. Therefore, a fusion region S may be formed at a desired location, and a uniform fusion region S may be formed.

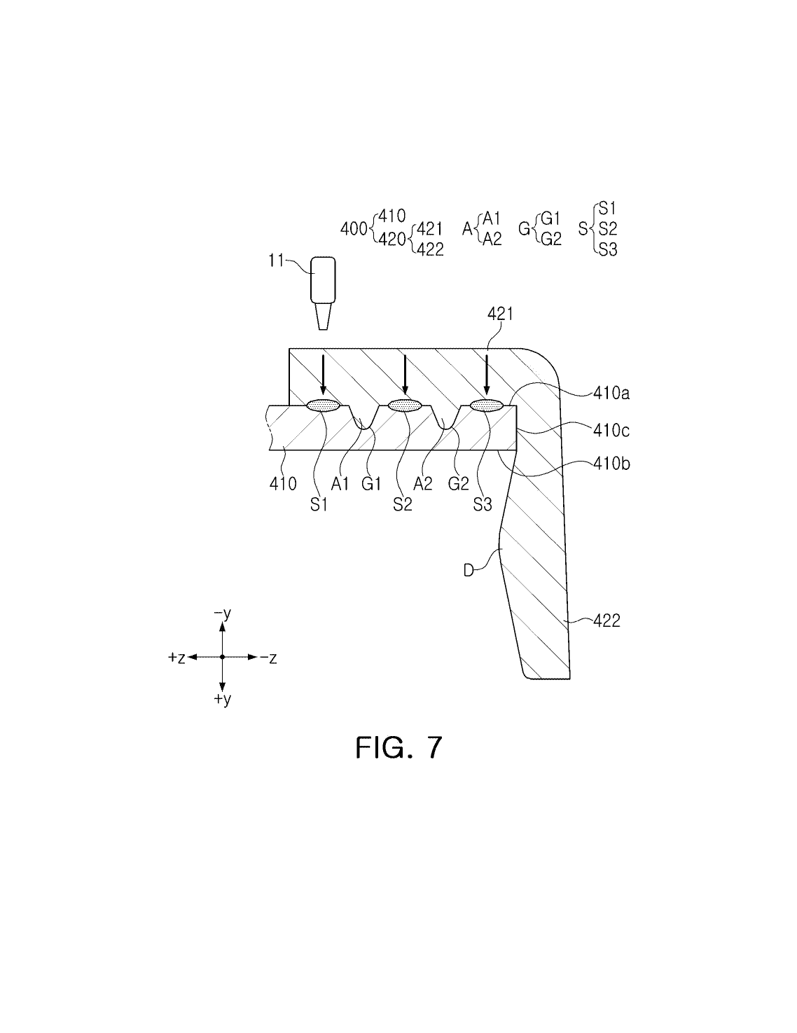

FIG. 7 is a partial cross-sectional view of a cap assembly 400 according to another embodiment.

The descriptions of the cap assembly 400 described in FIGS. 1 to 6 may also be applied to the cap assembly 400 of FIG. 7. Therefore, the following description will primarily focus on differences compared to the aforementioned cap assembly 400.

According to an embodiment, the protrusion (A) may include a plurality of protrusions (A), and the insertion groove (G) may include a plurality of insertion grooves (G). Therefore, the fixing effect of the protrusion (A) may be further enhanced.

For example, the protrusions (A) may include a first protrusion (A1) and a second protrusion (A2). The first protrusion (A1) is formed in a direction (+Z) toward the center of the cap plate 410 more than the second protrusion (A2), and conversely, the second protrusion (A2) is formed in a direction (-Z) opposite to the direction toward the center of the cap plate 410 more than the first protrusion (A1).

As the protrusion (A) includes the plurality of protrusions (A), the insertion groove (G) into which the protrusion (A) is inserted may also include the plurality of insertion grooves (G). For example, the insertion grooves (G) may include a first insertion groove (G1) into which the first protrusion (A1) is inserted, and a second insertion groove (G2) into which the second protrusion (A2) is inserted. Therefore, the fixing effect of the protrusion (A) may be further improved to form the fusion region (S) at a desired location, and a uniform fusion region (S) may be formed.

As the plurality of protrusions (A) and insertion grooves (G) are formed, the fusion region (S) may include a first fusion region (S1) formed in a direction (+Z) toward the center of the cap plate 410 relative to the first protrusion (A1), a second fusion region (S2) formed between the first protrusion (A1) and the second protrusion (A2), and a third fusion region (S3) formed in a direction (-Z) opposite to the direction toward the center of the cap plate 410 relative to the second protrusion (A2).

The fusion region (S) may be formed by laser welding or ultrasonic welding, as described above in FIGS. 5 and 6.

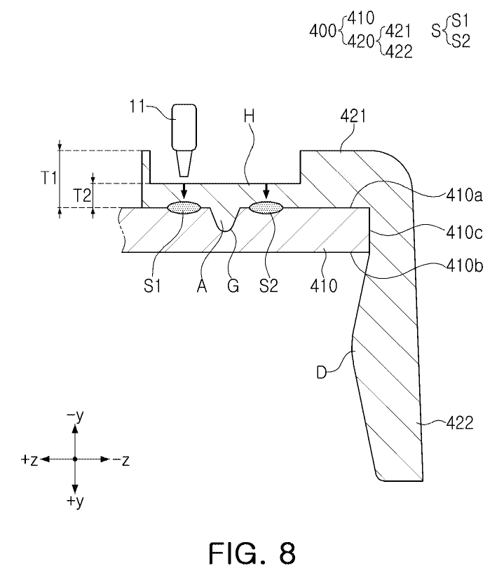

FIG. 8 is a partial cross-sectional view of a cap assembly 400 according to another embodiment.

The descriptions of the cap assembly 400 described in FIGS. 1 to 7 may also be applied to the cap assembly 400 of FIG. 8. Therefore, the description will primarily focus on differences compared to the aforementioned cap assembly 400.

According to an embodiment, the body 421 may include a concave portion (H) formed with at least a portion having a thinner thickness than other portions. In other words, the thickness (T2) of the concave portion (H) may be thinner than the thickness (T1) of other portions of the body 421.

By performing laser welding through the concave portion (H), more laser light may be irradiated to the contact surface between the sealing gasket 420 and the first surface 410a. In other words, by thinning the sealing gasket 420 through which the laser must penetrate, more laser light may reach the contact surface between the body 421 and the first surface 410a and transmit energy. Therefore, the fusion region (S) may be formed in a shorter time compared to the case without the concave portion (H). Furthermore, the fusion region (S) may be formed with less energy.

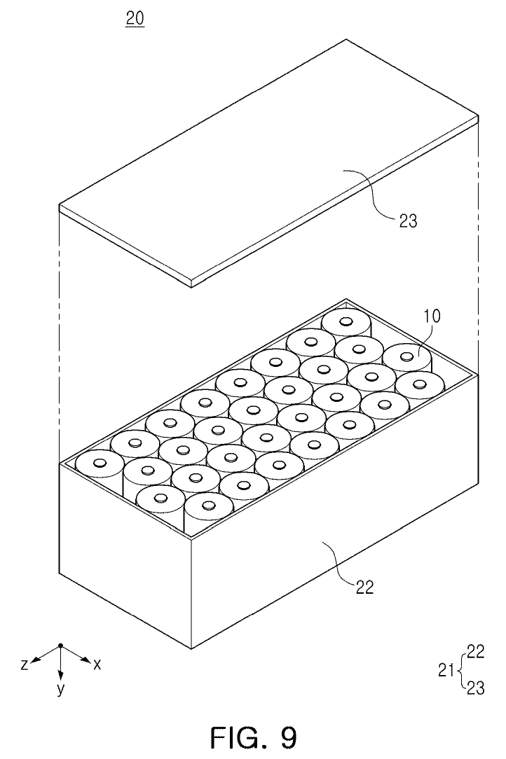

FIG. 9 is a perspective view of a battery module 20 according to an embodiment.

The descriptions of the battery cell 10 of FIGS. 1 to 8 may also be equally applied to the battery cell 10 provided in the battery module 20 of FIG. 9.

Referring to FIG. 9, the battery module 20 according to an embodiment includes a plurality of battery cells 10, and a module housing 21 that accommodates the plurality of battery cells 10.

The battery module 20 of the present disclosure is not limited in its specific type as long as it includes a plurality of battery cells 10. For example, the battery module 20 of the present disclosure is defined as including a battery pack or an energy storage device.

The module housing 21 may provide a space for accommodating the plurality of battery cells 10. The module housing 21 may include a housing body 22 that forms a space for accommodating the plurality of battery cells 10, and a housing cover 23 that covers the upper sides of the plurality of battery cells 10.

While example embodiments have been illustrated and described above, it will be apparent to those skilled in the art that modifications and variations could be made without departing from the scope of the present disclosure as defined by the appended claims.

What is claimed is:

1. A battery cell, comprising:
a cell case including a side wall forming a receiving space therein, and an end plate having a through-hole formed therein;
an electrode assembly disposed in the receiving space of the cell case; and
a cap assembly sealing the cell case,
wherein the cap assembly comprises:
a cap plate covering one side of the cell case;
a sealing gasket disposed between the cap plate and the cell case; and
a fusion region formed by fusion of at least a portion of a contact surface between the sealing gasket and the cap plate, and
wherein one of the sealing gasket and the cap plate includes a protrusion, and the other includes an insertion groove into which the protrusion is inserted.

2. The battery cell of claim 1, wherein:
the cap plate includes a first surface facing the receiving space, a second surface facing in an opposite direction to the first surface, and a third surface connecting the first surface to the second surface at the periphery of the first surface and the second surface, and
the fusion region is formed on the first surface.

3. The battery cell of claim 2, wherein the protrusion and the insertion groove are formed in a region in which the sealing gasket comes into contact with the first surface.

4. The battery cell of claim 2, wherein the fusion region includes a first fusion region formed in a direction toward the center of the cap plate, relative to the protrusion, and a second fusion region formed in a direction opposite to the direction toward the center of the cap plate, relative to the protrusion.

5. The battery cell of claim 1, wherein the fusion region is formed by laser welding or ultrasonic welding.

6. A cap assembly, comprising:
a cap plate covering one side of a cell case; and
a sealing gasket disposed between the cap plate and the cell case,
wherein at least a portion of the contact surface between the sealing gasket and the cap plate is fused to form a fusion region, and
wherein one of the sealing gasket and the cap plate includes a protrusion, and the other includes an insertion groove into which the protrusion is inserted.

7. The cap assembly of claim 6, wherein:
the protrusion includes a plurality of protrusions, and
the insertion groove includes a plurality of insertion grooves.

8. The cap assembly of claim 6, wherein:
the sealing gasket includes a body and an extension portion extending from the body, and
the extension portion includes a convex portion protruding toward the center of the cap plate.

9. The cap assembly of claim 8, wherein the body includes a concave portion having at least a portion formed thinner than other portions thereof.

10. The cap assembly of claim 8, wherein:
the cap plate comprises a first surface facing the body, a second surface facing in an opposite direction to the first surface, and a third surface connecting the first surface to the second surface at the periphery of the first surface and the second surface, and
the fusion region is formed on the first surface.

11. The cap assembly of claim 10, wherein the protrusion and the insertion groove are formed in a region in which the sealing gasket comes into contact with the first surface.

12. The cap assembly of claim 10, wherein:
the cap plate has a circular plate shape, and
the fusion region has a ring shape formed between the first surface and the body.

13. The cap assembly of claim 10, wherein the fusion region comprises a first fusion region formed in a direction toward the center of the cap plate, relative to the protrusion, and a second fusion region formed in a direction opposite to the direction toward the center of the cap plate, relative to the protrusion.

14. The cap assembly of claim 6, wherein the fusion region is formed by laser welding or ultrasonic welding.

15. A battery module, comprising:
a plurality of battery cells; and
a module housing accommodating the plurality of battery cells,
wherein at least one of the plurality of battery cells comprises:
a cell case including a side wall forming a receiving space therein and an end plate having a through-hole formed therein;
an electrode assembly disposed in the receiving space of the cell case; and
a cap assembly sealing the cell case,
wherein the cap assembly comprises:
a cap plate covering one side of the cell case;
a sealing gasket disposed between the cap plate and the cell case; and
a fusion region formed by fusion of at least a portion of a contact surface between the sealing gasket and the cap plate, and
wherein one of the sealing gasket and the cap plate includes a protrusion, and the other includes an insertion groove into which the protrusion is inserted.
